(19) United States
(12) Patent Application Publication
(10) Pub. No.: US 2025/0376169 A1
(43) Pub. Date: Dec. 11, 2025

(54) SOCIALLY-ADAPTED AUTONOMOUS MOBILE ROBOT

(71) Applicant: TOYOTA JIDOSHA KABUSHIKI KAISHA, Aichi-ken (JP)

(72) Inventors: Akira SHIBA, Susono-shi (JP); Nathan KAU, Setagaya-ku (JP); Zoltan BECK, Koto-ku (JP)

(73) Assignee: TOYOTA JIDOSHA KABUSHIKI KAISHA, Aichi-ken (JP)

(21) Appl. No.: 19/211,287

(22) Filed: May 19, 2025

(30) Foreign Application Priority Data
Jun. 6, 2024 (JP) 2024-091908

(51) Int. Cl. B60W 30/18; B60W 60/00; G05D 1/622

(52) U.S. Cl. CPC B60W 30/18163; B60W 60/0017; G05D 1/622; B60W 2554/802; B60W 2754/70

(57) ABSTRACT

To provide an autonomous mobile robot configured not to cause any comfort to a human moving along a passage. An autonomous mobile robot includes: a determination unit configured to determine whether or not a distance between the autonomous mobile robot and a person has a value less than a predetermined value when the autonomous mobile robot moves along a passage, and a travel control unit configured to change a widthwise traveling position of the autonomous mobile robot in a passage from a first position to a second position when the distance between the autonomous mobile robot and the person has a value less than predetermined value, the second position being a position closer to an edge of the passage than the first position is.

### CROSS REFERENCE TO RELATED APPLICATIONS

This application is based upon and claims the benefit of priority from Japanese patent application No. 2024-091908, filed on Jun. 6, 2024, the disclosure of which is incorporated herein in its entirety by reference.

### BACKGROUND

The present disclosure relates to a socially-compliant autonomous mobile robot.

Patent Literature 1 describes a technique for controlling the movement of an autonomous mobile robot to avoid interference with a person based on the personal area of the person in the moving direction of the autonomous mobile robot.
Patent Literature 1: Japanese Unexamined Patent Application Publication No. 2021-064372

### SUMMARY

The movement of an autonomous mobile robot based on the psychological boundary that one feels comfortable with has not been sufficiently studied, and from this viewpoint, there is room for making improvement in the movement of an autonomous mobile robot.

The present disclosure has been made in view of the above background, and an object of the present disclosure is to provide an autonomous mobile robot configured not to cause any discomfort to a person moving along the passage.

According to the present disclosure, a socially-compliant autonomous mobile robot includes: a determination unit configured to determine whether or not a distance between the autonomous mobile robot and a person has a value less than a predetermined value when the autonomous mobile robot moves along a passage; and a travel control unit configured to change a widthwise traveling position of the autonomous mobile robot along a passage from a first position to a second position when the distance between the autonomous mobile robot and the person has a value less than a predetermined value, the second position being a position closer to an edge of the passage than the first position is.

According to the present disclosure, it is possible to provide an autonomous mobile robot configured not to cause any discomfort to a human moving along the passage.

The above and other objects, features and advantages of the present disclosure will become more fully understood from the detailed description given hereinbelow and the accompanying drawings.

### BRIEF DESCRIPTION OF DRAWINGS

FIG. 1 is a diagram for describing an example of a configuration of an autonomous mobile robot according to a first embodiment;

FIG. 2 is a block diagram showing the configuration of the autonomous mobile robot according to the first embodiment;

FIG. 3 is a diagram illustrating an example of an operation of the autonomous mobile robot according to the first embodiment;

FIG. 4 is a diagram illustrating zones virtually defined around the autonomous mobile robot according to the first embodiment;

FIG. 5 is a diagram illustrating an operation of the autonomous mobile robot according to the first embodiment making a left turn; and

FIG. 6 is a diagram for explaining the operation of autonomous mobile robot going straight according to the first embodiment.

### DESCRIPTION OF EMBODIMENTS

### First Embodiment

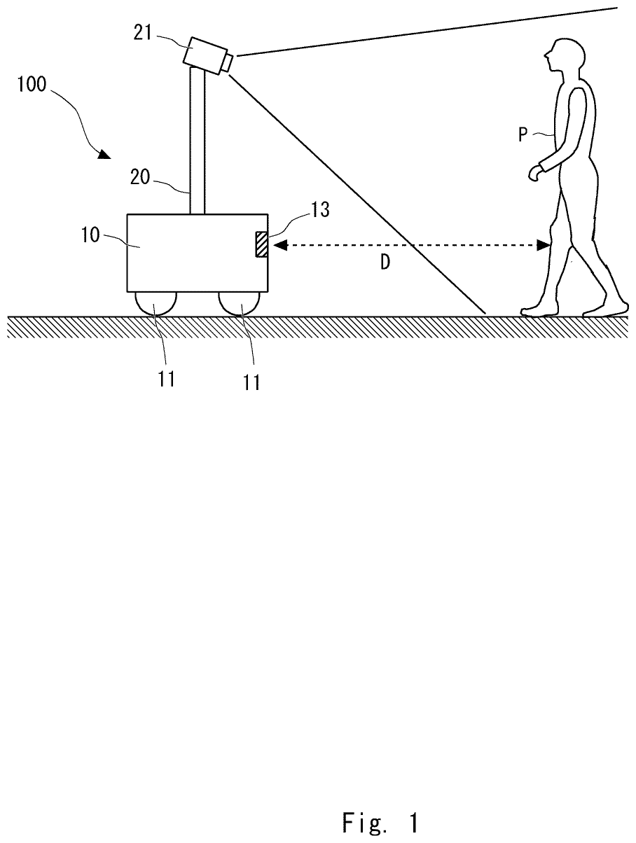

An example of a configuration of an autonomous mobile robot 100 according to a first embodiment will be described with reference to FIG. 1. The autonomous mobile robot 100 has wheels 11. The autonomous mobile robot 100 autonomously moves along a movement path to a destination. The autonomous mobile robot 100 may be an omnidirectional mobile robot.

The autonomous mobile robot 100 includes a body part 10, the wheels 11, a range sensor 13, a support pillar 20, and a camera 21. The body part 10 is a chassis for rotatably holding the wheels 11. The body part 10 is a housing for accommodating a battery (not shown), a motor for wheels, a control unit, and the like. The body part 10 may be a carrier truck for carrying a package or the like. The support pillar 20 for supporting the camera 21 is attached to the body part 10. In other words, the camera 21 is mounted on the support pillar 20.

The camera 21 does not need to be attached to the support pillar 20. For example, in the case where the autonomous mobile robot 100 is provided with a rack on which a package is put, the camera 21 may be attached to the upper part of the rack. In this case, the autonomous mobile robot 100 need not include the support pillar 20. The position where the camera 21 is installed need not be a high position and may be attached to the body part 10.

The camera 21 may be a CMOS (Complementary Metal Oxide Semiconductor) image sensor or a CCD (Charge Coupled Device) image sensor. The camera 21 may be installed in a smartphone or a tablet computer. The camera 21 may be a color camera such as an RGB camera. Specifically, the camera 21 may be a fisheye camera.

The camera 21 picks up an image around the autonomous mobile robot 100. For example, since the camera 21 faces the front side of the autonomous mobile robot 100, it picks up an image in a direction ahead of the autonomous mobile robot 100 in the moving direction of the autonomous mobile robot 100. Therefore, in the case where there is a person P in front of the autonomous mobile robot 100, the camera 21 picks up an image in which the person P is captured. The camera 21 outputs the picked-up image data to a control unit described later. The autonomous mobile robot 100 may further include another cameras 21 for picking up images on the rear side and the lateral side of the autonomous mobile robot 100.

The range sensor 13 is mounted on the side of the body part 10. The range sensor 13 is, for example, an optical sensor and measures the distance D therefrom to a person P in the vicinity of the range sensor 13. The range sensor 13 is preferably a two-dimensional range sensor such as a two-dimensional LiDAR (Light Detection And Ranging). The range sensor 13 may be provided on four sides of the body part 10, the front, the rear, the left, and the right sides, or may be provided on only a part of the four sides. The range sensor 13 includes a light source and a photosensor. The range sensor 13 emits measurement light toward ahead of the autonomous mobile robot 100 in the moving direction of the autonomous mobile robot 100. Then, the range sensor 13 detects the reflected light which is a light reflected on the person P or an object in the vicinity of the range sensor 13 (hereinafter collectively referred to as a vicinity point).

For example, the range sensor 13 measures the distance therefrom to the vicinity point as point cloud data. The range sensor 13 detects the distance from the range sensor 13 to the respective vicinity points in each direction by scanning the measurement light. The vicinity points include a wall, an obstacle, another robot, person, etc. For example, the range sensor 13 scans the laser light in an arbitrary plane such as a horizontal plane at regular angular intervals. The range sensor 13 detects the distance therefrom to the respective vicinity points by changing the scanning angle, that is, the detection direction.

The range sensor 13 can acquire position data indicating the distance from the range sensor 13 to the detection points. In the position data, the distance is correlated with the detection direction. That is, the position data of each detection point contains the detection direction (scanning angle) and the distance value. The range sensor 13 outputs the position data to a control unit described later. Here, the correspondence between the detection direction in the range sensor 13 and the angle of view in the camera 21 is known. That is, since the installation positions of the range sensor 13 and the camera 21 are fixed in the autonomous mobile robot 100, the position data of the range sensor 13 can be converted into xy coordinates in the image. That is, the detection points of the range sensor 13 indicated by the three-dimensional coordinates can be projected onto the two-dimensional image of the camera 21.

The autonomous mobile robot 100 may further include a direction indicator (not shown) indicating the moving direction of the autonomous mobile robot 100. The direction indicator is provided on the left and right sides of the autonomous mobile robot 100. The autonomous mobile robot 100 may further include a light source (not shown) that emits light to notify person P of the presence of the autonomous mobile robot 100 and a speaker (not shown) that emits a warning sound.

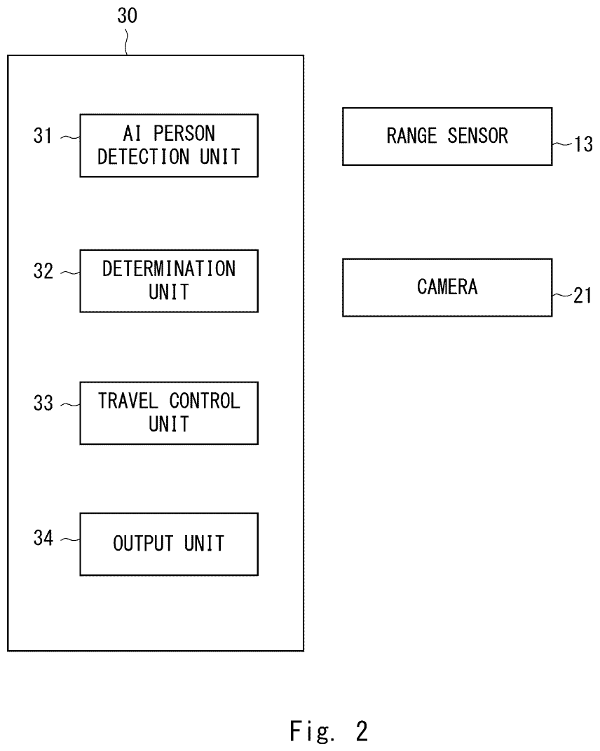

FIG. 2 is a block diagram showing the configuration of the autonomous mobile robot 100. A control unit 30 of the autonomous mobile robot 100 includes an AI (Artificial Intelligence) person detection unit 31, a determination unit 32, a travel control unit 33, and an output unit 34. The control unit 30 may be a computer including a processor and a memory. The functions of the AI person detection unit 31, the determination unit 32, the travel control unit 33, and the output unit 34 may be implemented by the processor executing programs stored in the memory.

The AI person detection unit 31 detects a bounding box (a box defining a boundary) surrounding the person in the image picked-up by the camera 21.

The AI person detection unit 31 executes a bounding box detection network to detect a bounding box surrounding the person P. A known technique can be employed for the bounding box detection. For example, the AI person detection unit 31 detects the person P in an image by performing image processing and detecting an object. The AI person detection unit 31 specifies a rectangular frame surrounding the person P as a bounding box in the image. The bounding box is shown by xy coordinates or the like in the image. The AI person detection unit 31 may detect a bounding box B by using a machine learning model based on deep learning or the like.

The AI person detection unit 31 determines whether or not each detection point detected by the range sensor 13 within the bounding box corresponds to the person P. For example, the AI person detection unit 31 uses a transformer which inputs position data including the detection direction and the distance from the range sensor 13 and outputs binary data indicating whether or not each detection point corresponds to the person. The transformer may be a transformed neural network generated by machine learning. The conversion neural network may be a machine learning model trained by self-supervised learning (SSL) using knowledge distillation.

For example, the AI person detection unit 31 generates binary data indicating the determination result. For example, in the case where a detection point detected by the range sensor 13 corresponds to the person P, the data value is “1”, and in the case where a detection point detected by the range sensor 13 does not correspond to the person P, the data value is “0”. Specifically, the AI person detection unit 31 binarizes each detection point included in the bounding box to generate binary data.

Then, the AI person detection unit 31 estimates the three-dimensional position of the person P based on the distance to the detection point determined to correspond to the person P. The AI person detection unit 31 calculates, for example, the median of the distances of the plurality of detection points as the distance from the range sensor 13 to the person P. The AI person detection unit 31 calculates the three-dimensional coordinates of the person P based on the distance from the range sensor 13 to the person P. The AI person detection unit 31 specifies the direction where the person P is based on the image or the position data. The AI person detection unit 31 estimates the three-dimensional position based on the distance and the direction. For example, the AI person detection unit 31 can estimate the three-dimensional coordinates of the person P based on the xy coordinates of the person P in the image picked-up by the camera 21 and the direction where the person P is in the position data.

The determination unit 32 determines whether or not the distance between the autonomous mobile robot 100 and the person P has a value less than a predetermined value based on the detection result of the AI person detection unit 31. The predetermined value (e.g., 8 m) is within a range of, for example, 7 m to 9 m. The predetermined value may be longer than the personal distance (e.g., 2 m) based on the personal area (also referred to as a personal space).

Specifically, the AI person detection unit 31 estimates the instantaneous position of the person without considering the temporal consistency, and the determination unit 32 uses Bayesian filter to make the detection result of the AI person detection unit 31 smooth in time. The determination unit 32 calculates, for example, by recursive Bayesian estimation, a belief indicating whether or not there is the person P within a range where the distance from the autonomous mobile robot 100 to the person P is a value less than a predetermined value. The state transition matrix and the measurement matrix may be adjusted to realize a desired false-negative rate and a false positive rate.

The determination unit 32 may use a tracking module instead of a Bayesian filter. The determination unit 32 may also determine whether the distance measured by the AI person detection unit 31 is a value less than a predetermined value.

The travel control unit 33 transmits a control signal to a motor that drives the wheels 11, thereby controlling the rotation of the wheels 11 and moving the autonomous mobile robot 100 to an arbitrary position. When the distance between the autonomous mobile robot 100 and the person P has a value less than a predetermined value, the travel control unit 33 changes the widthwise traveling position of the autonomous mobile robot 100 along the passage from the first position to the second position. The second position is closer to the edge of the passage than the first position is. The first position is, for example, the center of the passage. The second position may be close to the left-side edge of the passage or close to the right-side edge of the passage.

Specifically, the travel control unit 33 generates a movement path of the autonomous mobile robot 100 using the A* algorithm and have the autonomous mobile robot move along the movement path. The travel control unit 33 activates the lane-following module when the above-described belief exceeds a threshold value. The lane-following module adds the term C_{lanefollowing} as exemplified by Equation (1) to the cost function used in the A* algorithm. The lane-following module generates the term C_{lanefollowing} by using the lane map representing the direction vector of the lane defined as the passage by software.

$$\begin{matrix}[ Equation 1 ] & \\ {c}_{lane following} = 0 \text{.5} - 0.5 v \cdot d & ( 1 )\end{matrix}$$

Here, v (boldfaced) denotes a two-dimensional lane vector at the parent node of the edge. d (boldfaced) denotes a two-dimensional normalized vector representing the edge direction. The travel control unit 33 can drive the autonomous mobile robot 100 along the second lane using a lane map representing the direction vector of the lane corresponding to the second location. The lane map is represented as a discretized vector field.

The travel control unit 33 may generate a lane map based on the sensing results by the range sensor 13 and the camera 21. The lane need not be defined by hardware such as a marker. The travel control unit 33 generates a lane map by, for example, virtually dividing the passage into a plurality of lanes and determining a lane vector representing each of the plurality of lanes.

When A* algorithm is used without adding the term shown in Equation (1), movement path is generated in which the autonomous mobile robot 100 passes through the center of the passage. Therefore, by activating the lane-following module, the autonomous mobile robot 100 changes its widthwise traveling position from the center of the passage (i.e., the first position) to a position near the edge of the passage (i.e., the second position). When the distance between the autonomous mobile robot 100 and the person P exceeds a predetermined value, the travel control unit 33 can have the autonomous mobile robot 100 travel along the first lane corresponding to the first position. The first position is not limited to the center of the passage.

The travel control unit 33 may include a local planner that dynamically adjusts the movement path that avoids obstacles and the personal area of person P, the movement path being generated by the A* algorithm. The local planner may use a GPU (Graphics Processing Unit) to accelerate the processing speed of DWA (Dynamic Window Approach).

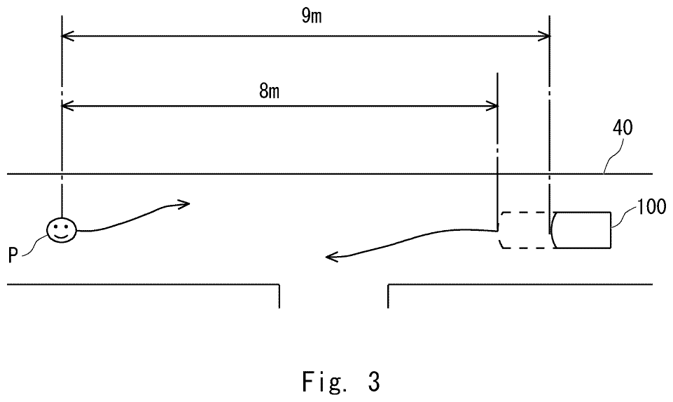

FIG. 3 is a diagram illustrating an example of how the autonomous mobile robot 100 moves (a movement method). The autonomous mobile robot 100, which is 9 m away from the person P, is shown by the solid lines, and the autonomous mobile robot 100, which is 8 m away from the person P, is shown by the dotted lines. The autonomous mobile robot 100 moves to the left in FIG. 3, and the person P moves to the right in FIG. 3. A passage 40 is a corridor or a path in which the person P and the autonomous mobile robot 100 can safely pass each other without stopping.

The autonomous mobile robot 100 basically moves along the center of the passage 40 and activates the lane-following mode when the distance between the autonomous mobile robot 100 and the person P is less than the predetermined value (e.g., 8 m). The autonomous mobile robot 100, for example, turns on its left direction indicator, starts moving to the left lane, and travels along the left lane.

Referring again to FIG. 2, the travel control unit 33 changes the rotational speed of the wheels 11 by transmitting a control signal to a motor that drives the wheels 11. The travel control unit 33 may change the moving speed of the autonomous mobile robot 100 based on the distance between the autonomous mobile robot 100 and the person P.

The output unit 34 outputs light or sound based on the distance between the autonomous mobile robot 100 and the person P. The output unit 34 may output light or sound by transmitting a control signal to a light source or a speaker (not shown). Also, the output unit 34 transmits a control signal to the direction indicator indicating the moving direction of the autonomous mobile robot 100 and causes the autonomous mobile robot 100 to turn on the direction indicator.

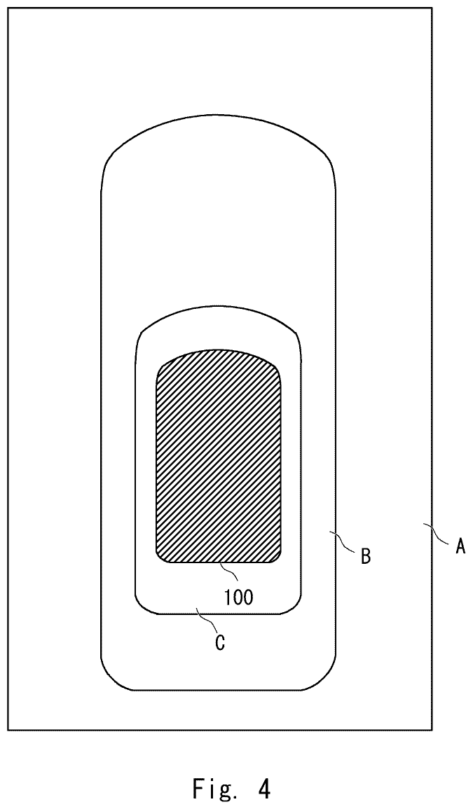

For example, as shown in FIG. 4, three zones of zones A, B, and Care virtually defined around the autonomous mobile robot 100. In the case where there is the person P in the zone A furthest from the autonomous mobile robot 100, the output unit 34 outputs light from the light source, for example.

In the case where there is the person P in the zone B closer to the autonomous mobile robot 100 than the zone A, for example, the output unit 34 outputs light from a light source, and the travel control unit 33 reduces the moving speed of the autonomous mobile robot 100. The travel control unit 33 may move the autonomous mobile robot 100 so that the distance between the autonomous mobile robot 100 and person P is maintained.

In the case where there is the person P in the zone C closer to the autonomous mobile robot 100 than the zone B, for example, the output unit 34 outputs light from a light source and outputs a warning sound from a speaker. The travel control unit 33 stops movement of the autonomous mobile robot 100.

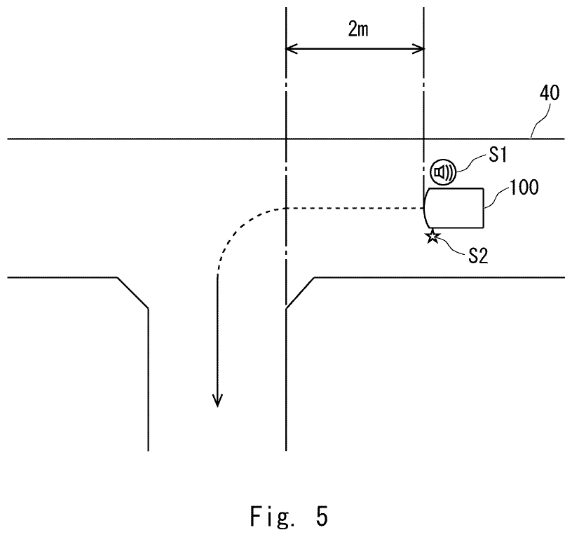

Referring to FIG. 5, an operation in which the autonomous mobile robot 100 makes a left turn at an intersection or a curve will be described. When the distance between the autonomous mobile robot 100 and an intersection or a curve becomes less than a predetermined value (e.g., 2 m), the travel control unit 33 reduces the traveling speed of the autonomous mobile robot 100. The travel control unit 33 resumes the traveling speed to the normal speed when the autonomous mobile robot 100 leaves the intersection or the curve. The path where the autonomous mobile robot 100 travels at a low speed is indicated by dotted lines, and the path where the autonomous mobile robot 100 travels at a normal speed is indicated by solid lines.

Here, when the distance between the autonomous mobile robot 100 and the intersection or curve becomes less than the predetermined value (e.g., 2 m), the output unit 34 turns on the direction indicator and outputs a warning sound from a speaker. The mark indicated by the reference symbol S1 indicates the output of the warning sound, and the mark indicated by the reference symbol S2 indicates the turned-on state of the direction indicator.

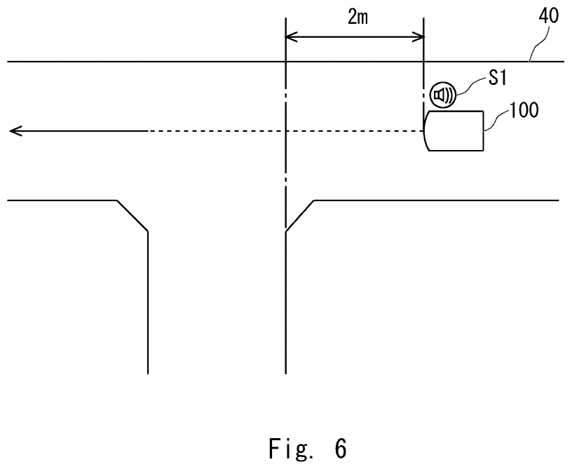

Referring to FIG. 6, the operation of the autonomous mobile robot 100 heading straight at an intersection or a curve will be described. When the distance between the autonomous mobile robot 100 and the intersection or the curve has a value less than the predetermined value, the travel control unit 33 reduces the moving speed of the autonomous mobile robot 100. When the autonomous mobile robot 100 leaves the intersection or the curve, the travel control unit 33 resumes the traveling speed to the normal speed. Here, the output unit 34 outputs a warning sound from a speaker when the distance between the autonomous mobile robot 100 and the intersection or curve becomes less than predetermined value (e.g., 2 m).

Next, the effect of the first embodiment will be described. The present inventors have found that a person P feels comfortable when the autonomous mobile robot 100 is traveling along the center of the passage and performs a collision avoidance operation when it approaches the person P. In this case, the person P can understand that the autonomous mobile robot 100 has performed a collision avoidance operation to avoid collision with the person P, and can safely pass by the autonomous mobile robot 100. When the autonomous mobile robot 100 is traveling on the left side of the passage 40, the person P may feel uneasy that the autonomous mobile robot 100 may suddenly change its traveling position in the passage 40.

In addition, the present inventors have found that it is preferable that the autonomous mobile robot 100 starts performing a collision avoidance operation when the distance between the autonomous mobile robot 100 and person P is about 8 m. In the case where the autonomous mobile robot 100 is configured to start performing a collision avoidance operation when the distance between the autonomous mobile robot 100 and the person P is long, the person P may not understand the reason why the autonomous mobile robot 100 has changed its traveling position, and may feel uneasy that the autonomous mobile robot 100 may suddenly change its traveling position again.

The autonomous mobile robot 100 according to the first embodiment changes its widthwise traveling position in the passage 40 to a position close to the edge of the passage 40 when the distance between the autonomous mobile robot 100 and the person P has a value less than a predetermined value. Thus, the autonomous mobile robot 100 does not cause any discomfort to the person P.

It should be noted that the present invention is not limited to the above-described embodiments, and may be appropriately modified without departing from the purport. Furthermore, according to the present disclosure, a part or all of the processing in the control unit 30 can be realized by having a processor such as a CPU (Central Processing Unit) execute a computer program. For example, the control unit 30 can be implemented as a device capable of executing a program such as a central processing unit of a computer. Various functions can also be realized by a program.

The program includes instructions (or software code) for causing the computer to perform one or more functions described in example embodiment when read into the computer. The program may be stored in a non-transitory computer-readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

It should be noted that present disclosure is not limited to the above embodiments and may be changed as appropriate to the extent that it does not deviate from the gist of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A socially-compliant autonomous mobile robot comprising:
a determination unit configured to determine whether or not a distance between the autonomous mobile robot and a person has a value less than a predetermined value when the autonomous mobile robot moves along a passage; and
a travel control unit configured to change a widthwise traveling position of the autonomous mobile robot in a passage from a first position to a second position when the distance between the autonomous mobile robot and the person has a value less than a predetermined value, the second position being a position closer to an edge of the passage than the first position is.

2. The autonomous mobile robot according to claim 1, wherein the first position is a position at a center of the passage.

3. The autonomous mobile robot according to claim 1, wherein
the predetermined value is within a range of 7 m to 9 m.

4. The autonomous mobile robot according to claim 1, wherein a lane corresponding to the second position is defined by software.

5. The autonomous mobile robot according to claim 1, further comprising an AI (Artificial Intelligence) person detection unit for detecting the person based on detection results of a plurality of sensors provided in the autonomous mobile robot.

6. The autonomous mobile robot according to claim 4, wherein
a two-dimensional vector representing the lane corresponding to the second position of the autonomous mobile robot is denoted by v (boldfaced) and a two-dimensional normalized vector representing the direction of an edge in which the autonomous mobile robot travels is denoted by d (boldfaced) in Equation (1),
$$\begin{matrix}[ Equation 1 ] & \\ {c}_{lane following} = 0.5 - 0.5 v \cdot d & ( 1 )\end{matrix}$$
and
the autonomous mobile robot travels along the lane corresponding to the second position based on cost functions including the term C_{lanefollowing}.
